(19) United States
(12) Patent Application Publication
(10) Pub. No.: US 2013/0019020 A1
(43) Pub. Date: Jan. 17, 2013

(54) SMART WIRELESS CONNECTION

(71) Applicants: Feng Kang, San Diego, CA (US); Leland Treebs, San Diego, CA (US); Yi Zhou, San Diego, CA (US)

(72) Inventors: Feng Kang, San Diego, CA (US); Leland Treebs, San Diego, CA (US); Yi Zhou, San Diego, CA (US)

(73) Assignee: SONY CORPORATION, Tokyo (JP)

(21) Appl. No.: 13/182,358

(22) Filed: Jul. 13, 2011

(51) Int. Cl. G06F 15/16

(52) U.S. Cl. 709/227

(57) ABSTRACT

Disclosed are approaches for automatically forming a wireless connection for a computing device. In one embodiment, a method can include: determining that a first wireless connection for a computing device has been lost; receiving a browser indication from a browser running on the computing device that a second wireless connection is desired for the computing device; providing, in response to the browser indication, an automatic connection indication to a user of the computing device via a user interface; receiving an acceptance indication from the user interface in response to the automatic connection indication; and establishing the second wireless connection for the computing device in response to the acceptance indication from the user interface.

### BACKGROUND

Wireless connections are sometimes lost due to an action of a user of a computing device. For example, a user may have wireless control settings that disable wireless connections outside of a given set of access points or wireless networks. As another example, a user may choose to work in off-line mode, thus selecting to not be on the Internet. In either case, a new wireless connection may ultimately be desired, and this presents some difficulty for users lacking requisite knowledge of wireless configurations.

### SUMMARY

Particular embodiments detect that a wireless connection is desired for a computing device, and automatically create the connection for the user.

In one embodiment, a method can include: determining that a first wireless connection for a computing device has been lost; receiving a browser indication from a browser running on the computing device that a second wireless connection is desired for the computing device; providing, in response to the browser indication, an automatic connection indication to a user of the computing device via a user interface; receiving an acceptance indication from the user interface in response to the automatic connection indication; and establishing the second wireless connection for the computing device in response to the acceptance indication from the user interface.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a block diagram of an example computing device.

FIG. 2 is a block diagram of an example computing device with a service for automatic wireless connection.

FIG. 3 is a block diagram of an example computing device with a plug-in for automatic wireless connection.

FIG. 4 is a flow diagram of an example method of automatically forming a wireless connection.

FIG. 5 is a flow diagram of an example user experience flow.

FIG. 6 is an example user interface for a first time accessing an automatic connection application.

FIG. 7 is an example user interface during an automatic connection attempt.

FIG. 8 is an example user interface for a timed out connection attempt.

FIG. 9 is an example user interface for an aborted connection attempt.

### DETAILED DESCRIPTION OF EMBODIMENTS

Wireless connection may be a problem for computing device users from time to time. For such users who may not have knowledge about wireless configurations and connections, an automatic connection approach may be desirable. In particular embodiments, automatic wireless connection of a computing device for the user can occur in response to a detection of a user's request for a web page being denied due to lack of an Internet connection.

Particular embodiments can employ application software, which may be implemented in the form of a service and/or a plug-in. A service can be a long-running executable that performs specific functions without substantial user intervention. For example, Windows services may start when the operating system is booted and run in the background as long as Windows is running, or such services can be started manually when required. Such services may resemble a daemon, which is a computer program that runs in the background, rather than under the direct control of a user. A plug-in is a set of software components that adds specific abilities to a larger software application. By using plug-ins, application functionality can be customized. For example, plug-ins (e.g., Adobe Flash Player, QuickTime, etc.) are commonly used in web browsers to play video, scan for viruses, and display new file types.

In particular embodiments, a service can run in the background to check for launches of browsers (e.g., Internet Explorer, Chrome, Firefox, etc.). Once a browser launch is detected, the background service can determine if an Internet connection exists or not. If a desired Internet connection does not exist, a wireless (e.g., Wi-Fi) connection may automatically be created for the user. Because such wireless connections may be automatically created, the user does not need extensive knowledge of wireless connection procedures.

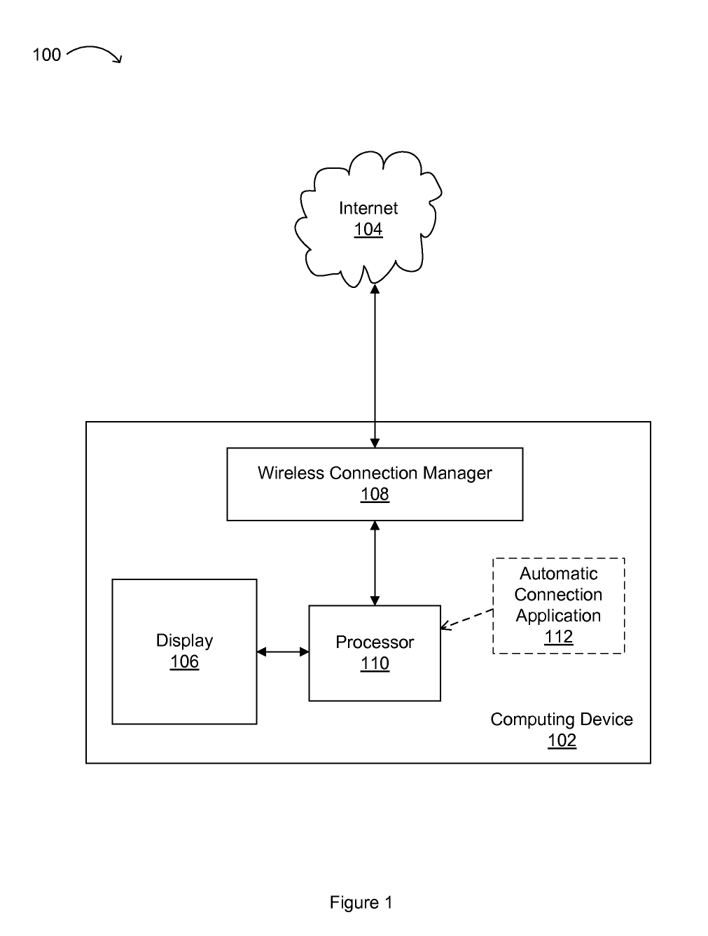

Referring now to FIG. 1, shown is a block diagram 100 of an example computing device. Computing device 102 can be any device (e.g., personal computer (PC), laptop computer, smart phone, tablet computer, web-enabled television, etc.) that is configurable to wirelessly connect to a network (e.g., the Internet). For example, computing device 102 can include display 106, processor 110, and wireless connection manager 108. Display 106 can be any suitable display type (e.g., liquid crystal display (LCD), light-emitting diode (LED), etc.), and may be a touchscreen for user input, or strictly a display screen. For example, display 106 can display a browser for navigating the Internet 104 using computing device 102. In addition, a user interface may be separate from or displayed on (e.g., via a touchscreen) display 106.

Processor 110 can be any general-purpose microprocessor or central processing unit (CPU), or a specialized microcontroller, and may control display 106 and wireless connection manager 108. Wireless connection manager 108 can include different configurations for various wireless networks or access points for accessing Internet 104. For example, user profiles for the operating system (OS) (e.g., Windows 7, Android, etc.) can include a list of wireless networks or access points configured and managed by wireless connection manager 108. Also, while the Internet 104 is shown in the particular example of FIG. 1, any suitable network supporting wireless connectivity can also be accommodated in certain embodiments.

Automatic connection application 112 can run on processor 110, and may include a background service and/or a plug-in application. For example, such a plug-in application can plug into a browser running on computing device 102 for navigating Internet 104. In certain embodiments, automatic connection application 112 can detect when a user of computing device 102 indirectly indicates a desire to access Internet 104. One example of such an indirect indication of a desire to access Internet 104 is activation of a browser on computing device 102 because browser activation is typically done in order to navigate the Internet.

Automatic connection application 112 may prompt the user to convey an awareness of this detected desire to use the Internet, and to ascertain whether the user wants the application to help arrange a wireless Internet connection. Automatic connection application 112 may also let the user know that the Internet connection issue has been resolved after such wireless connection. For example, if the user launches a browser (e.g., Internet Explorer) and doesn't have an Internet connection, a standard/default pop-up message that is normally provided by the browser may be overridden by automatic connection application 112.

For example, automatic connection application 112 may be a service that indicates that the user does not have any Internet connection, and the application aims to repair the connection problem, such as by forming a new wireless connection. As another example, automatic connection application 112 may be a plug-in inside the browser, and the plug-in may be used to replace the standard/default error message of the browser with an automatic connection message. The replacement automatic connection message may convey to the user the understanding that there is no Internet connection, and ascertain whether the user would like the connection to be created.

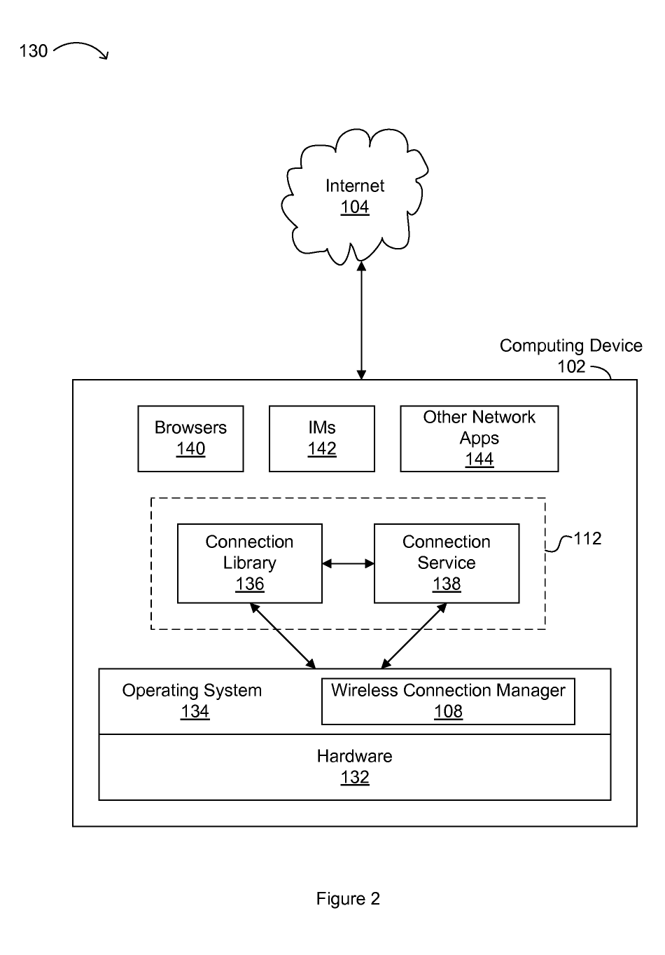

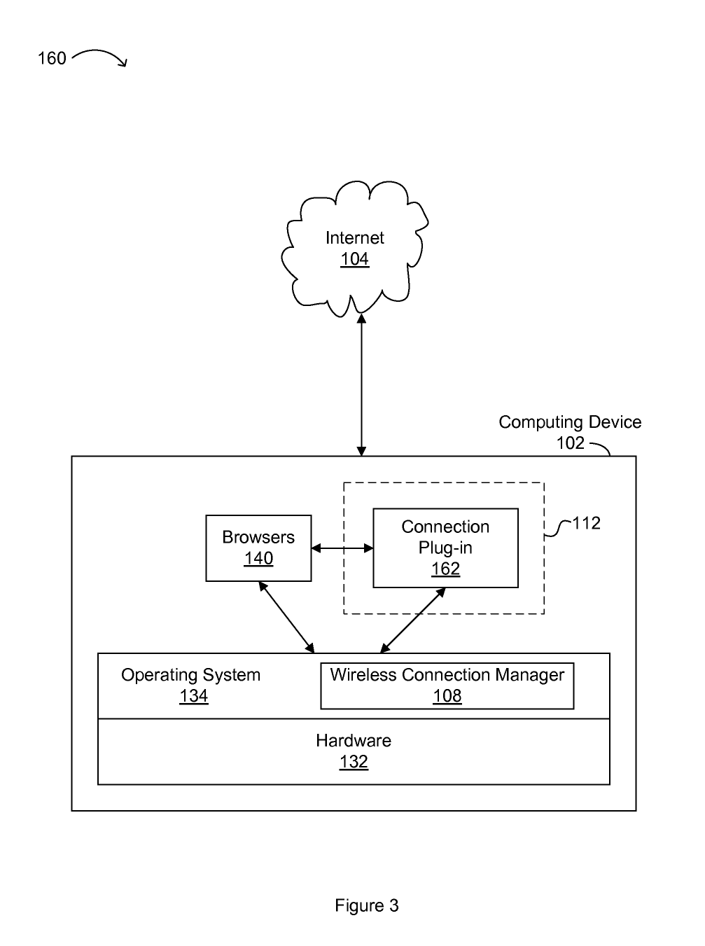

Referring now to FIGS. 2 and 3, examples of background service and browser plug-in configurations for computing device 102 are shown. FIG. 2 shows a block diagram 130 of an example computing device with a service for automatic wireless connection. In this example, hardware 132 may include processor 110, display 106, as well as other hardware components. Operating system 134 can include or be associated with wireless connection manager 108. For example, wireless connection manager 108 may be implemented in software that runs on hardware 132, and is controlled via operating system 134.

Automatic connection application 112 can include connection library 136 and connection service 138. Connection service 138 may be a background service that detects a connection status for computing device 102. For example, connection service 138 may determine that a user of computing device 102 desires that a connection before to Internet 104, such as by detecting activation of at least one of browsers 140, instant messaging applications 142, or other network applications 144. Connection library 136 may be used to create the automatic wireless connection in response to the detection made by connection service 138. For example, connection library 136 can include various implementations and steps that an advanced user might take in order to establish a wireless connection, such as by obtaining user names and passwords from logs of approved connections from user profiles maintained by operating system 134 and/or wireless connection manager 108. In this fashion, previously profiled wireless networks can be utilized by connection library 136 to make the wireless connection.

FIG. 3 shows a block diagram 160 of an example computing device with a plug-in for automatic wireless connection. In this example, automatic connection application 112 can include connection plug-in 162, which may operate as an add-on to at least one of browsers 140. As discussed above, connection plug-in 162 may be used to replace the standard/default error message of the browser 140 with an automatic connection message. Particular embodiments also support hybrid combinations of the service configuration shown in FIG. 2 and the plug-in configuration shown in the example of FIG. 3. In one such example hybrid flow, an initial connection problem may utilize connection plug-in 162, and subsequent connection problems utilize connection service 138.

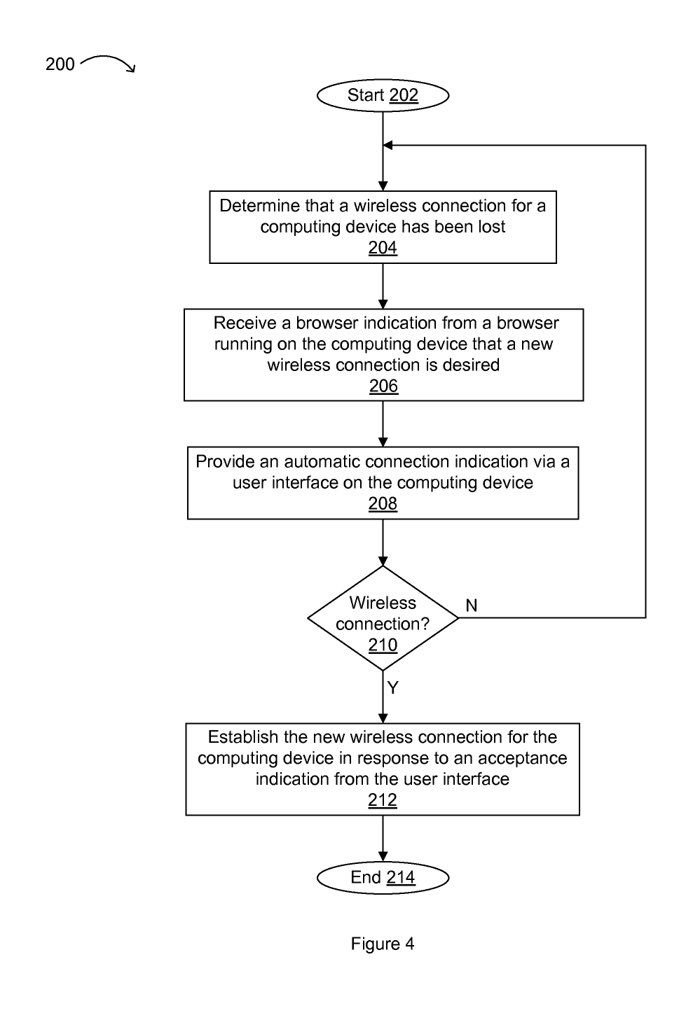

Referring now to FIG. 4, shown is a flow diagram 200 of an example method of automatically forming a wireless connection. The flow begins 202, and in 204 it can be determined that a wireless connection for a computing device has been lost. Thus, computing device 102 may previously have been connected to the Internet, and an associated user profile may thus have been created, but now the connection is lost. Alternatively, certain embodiments can automatically connect to an unsecured network or free public wireless network that is in range without having previously created a user profile from a connection that is now lost. In 206, a browser indication can be received to indicate from a browser running on the computing device that a new wireless connection is desired for the computing device. For example, activation of the browser with no Internet connection may be used to determine that the user wishes to have a wireless connection to navigate the Internet.

In 208, in response to the browser indication, an automatic connection indication may be provided to a user of the computing device via a user interface. A user may then indicate in 210 whether to allow the application (e.g., a service, a plug-in, etc.) to automatically connect computing device 102 to the Internet via an acceptance indication from the user interface. For example, the user may make a selection (e.g., via a mouse click, touchscreen selection, etc.) of an automatic connection box on the user interface in order to generate the acceptance indication (or to indicate not to use the automatic connection process). If the user does not want the wireless connection to be automatically established using the application (210), the flow can return to the beginning (202).

However, if the user does want the application to automatically establish the wireless connection, this can be performed in response to the acceptance indication from the user interface in 212, thus completing the flow 214. Various steps may also be modified in the flow or order in accordance with particular embodiments. For example, after establishing the new wireless connection in 212, the flow may return to determine that a wireless connection has been lost in 204. Also, step 208 may be skipped in some cases, such as when a user has indicated a desire to always automatically connect when a loss connection is detected (204) and a browser is activated (e.g., 206). Thus, a user may provide the automatic connection indication of 208 as a default setting. Further, the default setting can be made in advance of any wireless connection activity, or as a result of a first encounter of a problem with a wireless connection being lost. In this case, subsequent automatic wireless connections would not prompt the user front automatic connection indication.

A wireless connection may be determined as lost (e.g., 204) by a variety of ways. In one example, the user may not be connected because the user has explicitly chosen to disconnect from the Internet. In such a case, computing device 102 may not automatically get reconnected without use of automatic connection application 112. In another example, the user may have a preference selected whereby the user does not want to always connect to an available wireless network. In another example, there may be different access gateways from different buildings between which the user is transporting computing device 102, and a release/renew of the Internet protocol (IP) address may be needed when going from one building to another.

In certain embodiments, a background service (e.g., automatic connection application 112) may prompt the user to ask if the user needs help establishing a wireless connection (e.g., step 208). Such a background service may be an “event” service that can be implemented to detect events (e.g., browser launch or activation, Internet connection failure message events) for various browsers. The background event service may still allow the user to see a default message from the browser that indicates a connection error. There may also be an event service that includes a pop-up user interface (UI) that informs the user of a possibility or attempt for automatically connecting to the Internet.

The browser can report to the service that there is an Internet connection desired but missing (e.g., step 206), and then the event service may produce the pop-up UI. In another example, the wireless connection problem may be detected and automatically fixed, followed by a UI to inform the user. Another option is to let the user know that there is an ongoing attempt to fix the wireless connection via a UI, and the user is allowed to cancel the operation if desired. Yet another option is to have the user indicate from the beginning (as a default selection) that they want the wireless connection problem fixed whenever the connection problem occurs.

In certain embodiments, plug-in application (e.g., automatic connection application 112) inside the browser can be used to detect that no Internet connection exists when one is desired. In this case, a standard or default browser error message to that effect (e.g., with a selector button to diagnose connection errors) may be intercepted and replaced with a message driven by automatic connection application 112. The plug-in can perform such browser message replacement to control what the browser looks like, but a service implementation may not be equipped to perform this replacement function. However, the service may be aware of what the browser is doing when a plug-in is not utilized. Also, the plug-in may be implemented for a specific browser (e.g., IE 9), but the service may operate independently of the particular browser that is employed.

Particular embodiments can support various forms of automatic connection application 112. For example, pure service, pure plug-in, or hybrid service/plug-in applications can be accommodated. For example, one hybrid flow may start off using a plug-in and then proceed to a service thereafter. In any event, particular embodiments can utilize a trigger for the automatic wireless connecting of a connection error message from the browser, a launching/activation of the browser, or any other suitable browser-based trigger. Thus for example, only when there is an error message (e.g., a no connection message) generated by the browser can the automatic connection procedure be invoked.

Particular embodiments may utilize the browser generating an error message (as opposed to strictly browser launching) to trigger possible automatic connection to accommodate other browser-based functions, such as the off-line mode that can be selected from the tools menu. For example, if the user has selected off-line mode, and then launches the browser, no error message (and no automatic connection trigger) will be generated because the browser knows that the user wants to work in off-line mode. However, the browser does generate an error message in such a case if the browser is looking for a uniform resource locator (URL) found on the Internet (e.g., http://www.sony.com). In this case, the browser figures out that the user does desire Internet access even though the user has selected the option of working in off-line mode, and as a result the error message is generated by the browser, thus triggering the automatic connection process. Alternatively, if the user is only trying to work locally (e.g., C:\Documents) in the off-line mode, the browser may not generate such an error message, and the automatic connection process is thus not invoked.

Thus if the user already has a browser open and the Internet connection gets lost, and the user types in a URL for an Internet address, then the browser generated error message will be sent, and the automatic connection service is invoked. However, if the user is only accessing a local “C:” directory, such as navigating a local computer disc, no error message may be generated by the browser. For example, such local directory structures that might look like online addresses might be used when someone is developing an application, and the user is relying on the browser to tell the automatic connection application when the wireless connection is needed so as to not interfere with the user's intended operation of the browser.

Thus, particular embodiments actually wait for the browser operation to convey that the user needs a connection, in order to invoke the automatic connection application (e.g., at the application layer). Accordingly, if a user has selected off-line mode, when the user opens a browser, the browser is not concerned about the status of the wireless connection because the browser assumes the user is trying to work off-line. It is only when the user attempts to actually access an Internet address where the browser would then send the error message, thus invoking the automatic connection application.

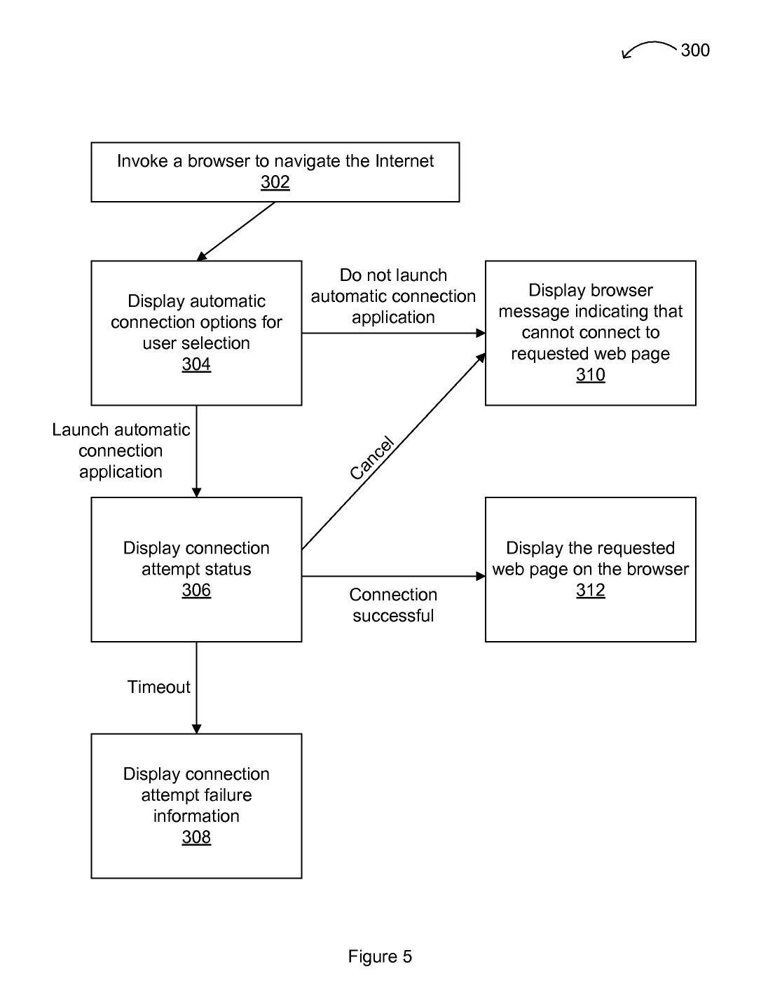

Referring now to FIG. 5, shown is a flow diagram 300 of an example user experience flow. In 302, a browser may be invoked for navigation of the Internet. In 304, automatic connection options for user selection may be displayed on a UI (e.g., display 106). Here, the user can make selections as to whether to enable or disable the automatic connection operation. The user may choose to launch the automatic connection application, and the connection attempt status may be displayed at 306. If the connection attempt fails due to timeout (e.g., failure to connect after a predetermined amount of time), connection attempt failure information may be displayed at 308.

If the user either selects not to launch the automatic connection application in a user selection option displayed at 304, or the user cancels the attempted connection during the attempt at 306, a browser message can be displayed to indicate that the requested web page cannot be connected to or displayed at 310. For example, this browser message displayed at 310 may be the default browser message indicating a lack of connection when a web page is requested. However, the requested web page can be displayed on the browser at 312 when the connection is successful.

In order to display the automatic connection options for user selection at 304, a plug-in to the browser can be used for replacing the default browser error message, such as for the first time the connection error occurs. Via this plug-in replacement message at 304, the user may choose to continue with the automatic connection (and proceed to 306) or not (and proceed to 310, which is the default browser message that was initially replaced). After a successful resolution of the connection problem, the service may then indicate this connection status to the user (e.g., via the display at 306, via a separate pop-up, etc.). In addition, the user may be aware of the automatic connection application being a friendly service type of application that resolves the connection issue (e.g., for future considerations).

Particular embodiments may thus operate substantially at the application level, as opposed to the link level. In an example case, the user somehow has previously indicated a desire for the wireless connection to be stopped, but now is opening a browser or otherwise indicating a desire to presently connect to the Internet. Thus, a previous disconnection event might be that the user has done something to disrupt the normal connection, so the user would have had a connection, but the connection was defeated or broken. Now, the user is doing something to indicate that the user obviously wants a connection again, such as a browser access operation. In this fashion, particular embodiments react to user actions, whereby the user has previously broken a connection, but wants the same or a new connection now, and perhaps has since forgotten that the connection was previously disabled.

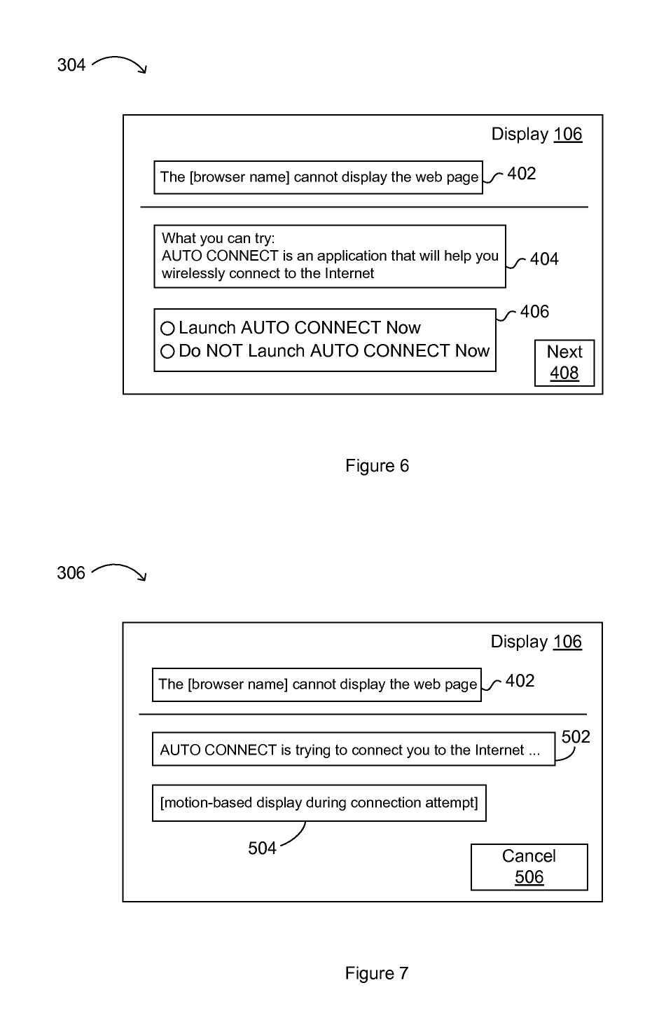

FIG. 6 shows an example user interface 304 for a first time accessing an automatic connection application. This example interface display may correspond, e.g., to step 208 in FIG. 4. On display 106, a message indicating that the browser cannot display the web page is shown in 402. Instructions to the user about the automatic connection (AUTO CONNECT) application option may be displayed in 404. Selections for the user to either launch the automatic connection application, or not, are shown in 406. To proceed to the next step once a selection is made, a next button 408 can be used. Thus for example, the UI can ascertain whether the user wants the automatic connection application to run, to run and not to ask again, and so on.

FIG. 7 shows an example user interface 306 during an automatic connection attempt, in response to the user electing to launch the automatic connection application. This example interface display may correspond, e.g., to step 212 in FIG. 4. A message can be displayed at 502 to indicate that the application (e.g., automatic connection application 112) is trying to connect the user to the Internet. A motion-based display at 504 can indicate to the user that the attempt is occurring as represented by the motion. Once the attempt is completed, successfully or not, the motion aspect of display 504 can stop. If the user wishes to cancel the attempted connection during the attempt (e.g., while motion is occurring in 504), the user can select cancel button 506.

In making the wireless connection, a library (e.g., connection library 136) may be utilized that includes implementations and steps that an advanced user might take in order to establish a wireless connection. For example, user names and passwords can be obtained from logs of approved connections from user profiles maintained by the OS (e.g., Windows 7) and/or wireless connection manager 108. Calls can thus be performed to make the wireless connections based on previously profiled wireless networks. Thus, standard approaches for setting up a wireless connection may be utilized in an automated fashion, and triggered by browser events, in certain embodiments. The automatic connection application 112 may thus check for at least one such profile, and set up the wireless connection accordingly. For example, multiple profiles may already be ranked by wireless connection manager 108 and/or the OS in an order from strongest signal to weakest, with the strongest being chosen for the Wi-Fi connection.

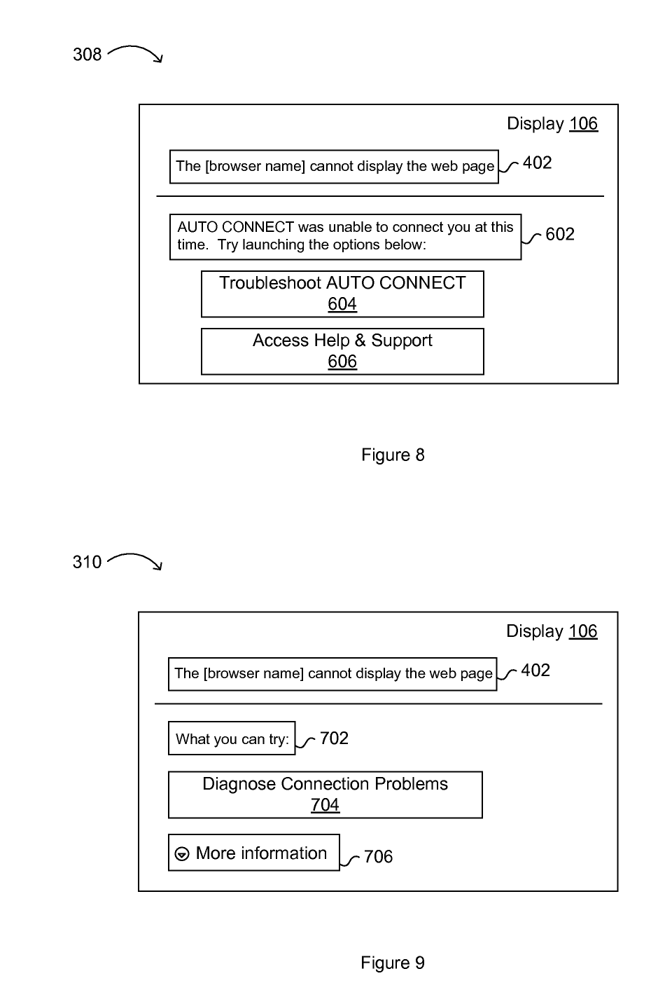

FIG. 8 shows an example user interface 308 for a timed out connection attempt. A message indicating that the connection attempt has failed, and indicating the available options can be shown in 602. For example, a troubleshooting button 604 can be used to activate a troubleshooting operation for the automatic connection application. Also, button 606 can be used for accessing help and support, such as for searching the term “wireless” for more detailed wireless connection support information.

FIG. 9 shows an example user interface 310 for an aborted connection attempt. For example, the user may choose not to activate the automatic connection application at 406, or may choose to cancel an ongoing connection attempt at 506. In 310, box 702 can indicate options for the aborted connection attempt. Button 704 can be used to select the option to diagnose connection problems, and button 706 can be used for more information (e.g., about the connection problem, wireless configurations, etc.).

In this fashion, wireless connections can be automatically created in response to browser-based events. Example browser-based events include browser generated error messages that indicate no Internet connection in response to user actions expressing a desire to connect to the Internet. Particular embodiments may detect browser launching and/or URL searching while in off-line mode, as well as any other suitable browser events, to trigger an automatic connection application.

Although the description has been described with respect to particular embodiments thereof, these particular embodiments are merely illustrative, and not restrictive. For example, while a certain computing device and network access structure has been shown, any suitable wireless network capable computing devices and/or networks can be accommodated in particular embodiments.

Any suitable programming language can be used to implement the routines of particular embodiments including C, C++, C#, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method, comprising:
determining that a first wireless connection for a computing device has been lost;
receiving a browser indication from a browser running on the computing device that a second wireless connection is desired for the computing device;
providing an automatic connection indication to a user of the computing device via a user interface, wherein the automatic connection indication is provided in response to the browser indication;
receiving an acceptance indication from the user interface in response to the automatic connection indication; and
establishing the second wireless connection for the computing device in response to the acceptance indication from the user interface.

2. The method of claim 1, further comprising:
intercepting a message from the browser that would have indicated a lack of the second wireless connection on the user interface.

3. The method of claim 2, wherein the automatic connection indication is provided in place of the intercepted message.

4. The method of claim 1, wherein the first and second wireless connections are to a same access point.

5. The method of claim 1, wherein the first and second wireless connections are to different access points.

6. The method of claim 1, further comprising:
displaying a requested web page on the browser in response to the second wireless connection being established.

7. The method of claim 1, wherein the receiving the browser indication comprises using a background service that monitors the browser to determine connection problems.

8. The method of claim 1, further comprising:
accessing a user profile stored on the computing device in order to establish the second wireless connection.

9. The method of claim 1, wherein the receiving the browser indication comprises using a plug-in application in the browser.

10. An apparatus comprising:
one or more processors; and
logic encoded in one or more tangible media for execution by the one or more processors, and when executed being operable to perform:
determining that a first wireless connection for a computing device has been lost;
receiving a browser indication from a browser running on the computing device that a second wireless connection is desired for the computing device;
providing an automatic connection indication to a user of the computing device via a user interface, wherein the automatic connection indication is provided in response to the browser indication;
receiving an acceptance indication from the user interface in response to the automatic connection indication; and
establishing the second wireless connection for the computing device in response to the acceptance indication from the user interface.

11. The apparatus of claim 10, wherein the logic when executed is further operable to perform:
intercepting a message from the browser that would have indicated a lack of the second wireless connection on the user interface.

12. The apparatus of claim 11, wherein the automatic connection indication is provided in place of the intercepted message.

13. The apparatus of claim 10, wherein the first and second wireless connections are to a same access point.

14. The apparatus of claim 10, wherein the first and second wireless connections are to different access points.

15. The apparatus of claim 10, wherein the logic when executed is further operable to perform:
displaying a requested web page on the browser in response to the second wireless connection being established.

16. The apparatus of claim 10, wherein the receiving the browser indication comprises using a background service that monitors the browser to determine connection problems.

17. The apparatus of claim 10, wherein the logic when executed is further operable to perform:
accessing a user profile stored on the computing device in order to establish the second wireless connection.

18. The apparatus of claim 10, wherein the receiving the browser indication comprises using a plug-in application in the browser.

19. A computer-readable storage medium having instructions stored thereon for execution by one or more processors, and when executed being operable to perform:
determining that a first wireless connection for a computing device has been lost;
receiving a browser indication from a browser running on the computing device that a second wireless connection is desired for the computing device;
providing an automatic connection indication to a user of the computing device via a user interface, wherein the automatic connection indication is provided in response to the browser indication;
receiving an acceptance indication from the user interface in response to the automatic connection indication; and
establishing the second wireless connection for the computing device in response to the acceptance indication from the user interface.

20. The storage medium of claim 19, wherein the instructions when executed are further operable to perform:
intercepting a message from the browser that would have indicated a problem with the second wireless connection on the user interface.
